(19) United States
(12) Patent Application Publication
(10) Pub. No.: US 2010/0212554 A1
(43) Pub. Date: Aug. 26, 2010

(54) Carrying Apparatus Capable of Preventing Deviation of a Positioning Platform Carried by it

(76) Inventors: Chi-Pin CHOU, Taichung (TW); Ming-Hung Hsieh, Taichung (TW)

Correspondence Address: Dr. BANGER SHIA;Patent Office of Bang Shia, 102 Lindencrest Ct., Sugar Land, TX, 77479-5201, US

(21) Appl. No.: 12/390,475

(22) Filed: Feb. 22, 2009

(51) Int. Cl. B23Q 1/28

(52) U.S. Cl. 108/143

(57) ABSTRACT

A carrying apparatus capable of preventing deviation of a positioning platform carried by it is provided with a positioning platform at the top thereof and a support base at the bottom thereof. At both lateral sides of the carrying apparatus are provided an anti-deviation structure, respectively, so as to restrict the positioning platform and prevent it from being deviated.

### BACKGROUND OF THE INVENTION

1. Field of the Invention

The present invention relates to a carrying apparatus for carrying a platform, and more particularly to a carrying apparatus capable of preventing deviation of a positioning platform carried by it.

2. Description of the Prior Art

Currently, when moving various positioning platforms on carrying apparatuses, the positioning platforms are likely to deviate because of human carelessness or poor skill. As a result, the positioning platforms will probably fall off or cannot be moved into the correct position as desired. So far, the best solution to this problem is to avoid causing human carelessness.

The present invention has arisen to mitigate and/or obviate the afore-described disadvantages.

### SUMMARY OF THE INVENTION

The primary objective of the present invention is to provide a carrying apparatus capable of preventing deviation of a positioning platform carried by it.

To achieve the objective of the present invention, the carrying apparatus is provided with a positioning platform at one side thereof and a support base at the other side thereof. At both lateral sides of the carrying apparatus are provided a plurality of anti-deviation structures. The respective anti-deviation structures comprise a support member and a restriction member. The support members are fixed to the lateral sides of the carrying apparatus, and the restriction members are fixed to the support members, so as to restrict the positioning platform.

A universal wheel is mounted on a stopping portion of the restriction member of the respective anti-deviation structures.

In the top surface of the carrying apparatus is defined with least one sliding way, and on the bottom surface of the positioning platform is provided a plurality of wheels in such a manner that the wheels are in rolling contact with the sliding way the carrying apparatus.

It is apparent from the above-mentioned descriptions that the present invention has an advantage that it utilizes the anti-deviation structures to restrict the positioning platform, so as to prevent the positioning platform from being deviated.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a plan view of a carrying apparatus capable of preventing deviation of a positioning platform carried by it in accordance with the present invention;

FIG. 2 is an exploded view of the carrying apparatus capable of preventing deviation of a positioning platform carried by it in accordance with the present invention;

FIG. 3 is an assembly perspective view of the carrying apparatus capable of preventing deviation of a positioning platform carried by it in accordance with the present invention;

FIG. 4 is a partial enlarged view of the carrying apparatus capable of preventing deviation of a positioning platform carried by it in accordance with the present invention;

FIG. 5 is an illustrative view showing the carrying apparatus capable of preventing deviation of a positioning platform carried by it cooperating with wheels in accordance with the present invention;

FIG. 6 is an assembly perspective view of the carrying apparatus capable of preventing deviation of a positioning platform carried by it cooperating with universal wheels in accordance with the present invention; and

FIG. 7 is a partial enlarged view of the carrying apparatus capable of preventing deviation of a positioning platform carried by it in accordance with the present invention.

### DETAILED DESCRIPTION OF THE PREFERRED EMBODIMENTS

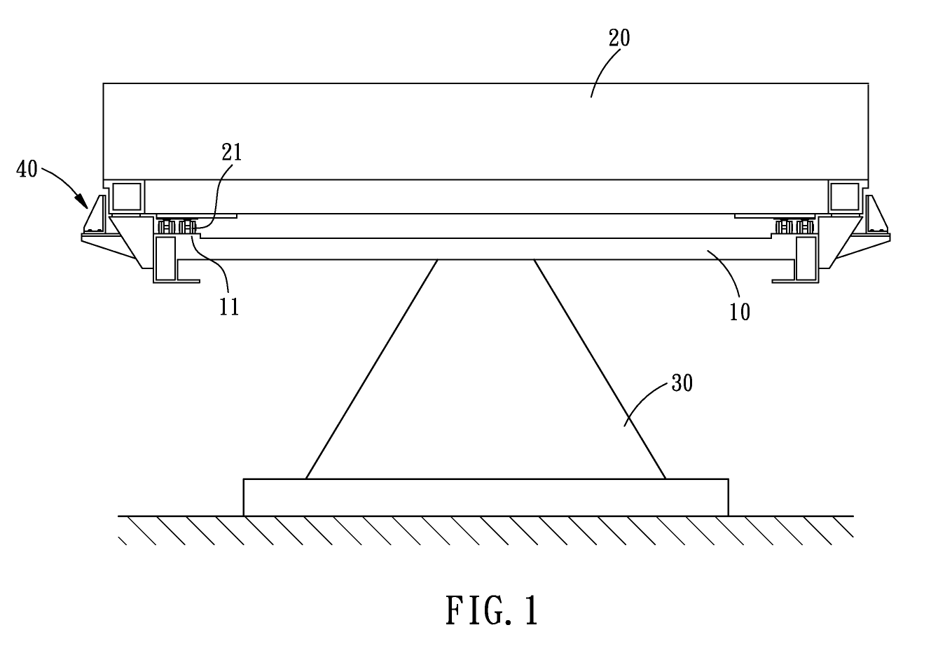

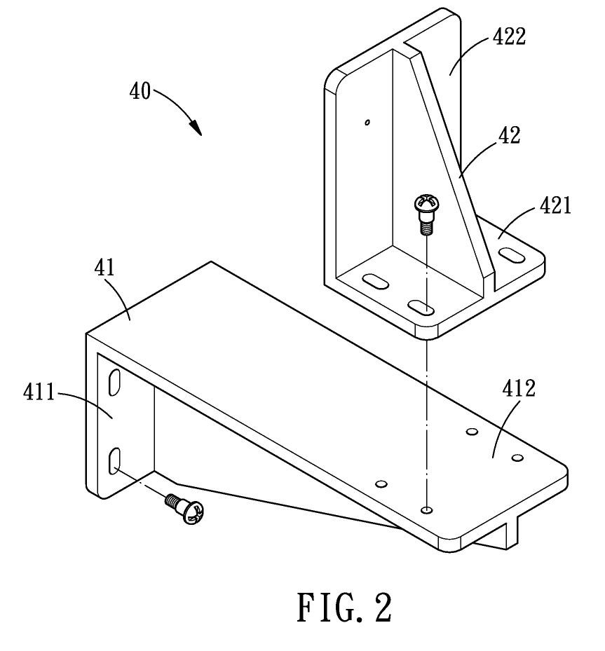

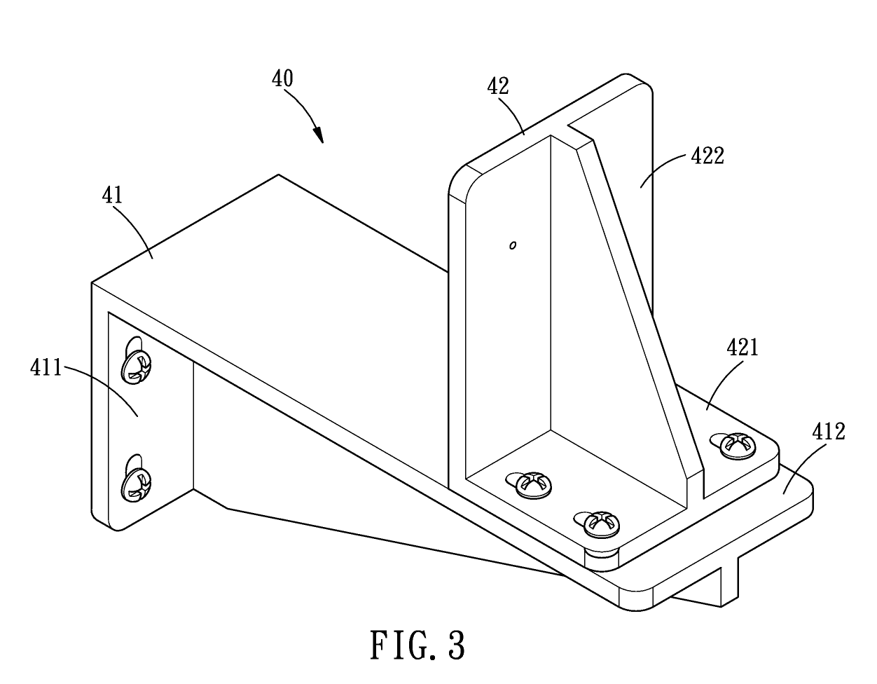

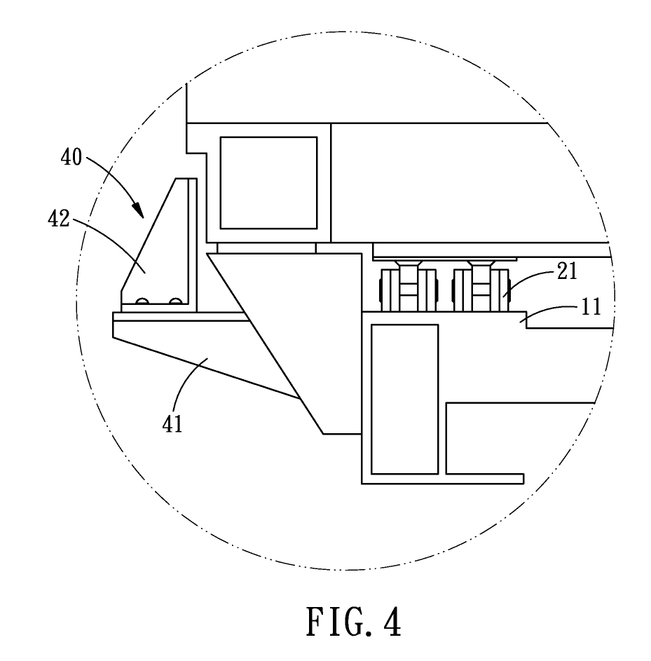

Referring to FIGS. 1-4, a carrying apparatus 10 capable of preventing deviation of a positioning platform carried by it in accordance with the present invention is shown, on the top of the carrying apparatus 10 is carried a positioning platform 20, at the bottom of the carrying apparatus 10 is provided a support base 30, and at both lateral sides of the carrying apparatus 10 are provided an anti-deviation structure 40, respectively.

Each anti-deviation structure 40 comprises a support member 41 and a restriction member 42. The support member 41 is folded to form an assembly portion 411 and a carrying portion 412. The restriction member 42 is folded to form an assembly portion 421 and a stopping portion 422. The assembly portion 411 of the support member 41 is screwed on one of the lateral sides of the carrying apparatus 10 by screws, and the carrying portion 412 of the support member 41 is faced upward. The assembly portion 421 of the restriction member 42 is screwed on the carrying portion 412 of the support member 41 by screws, and the stopping portion 422 of the restriction member 42 is faced to one lateral side of the positioning platform 20, so as to restrict the positioning platform 20.

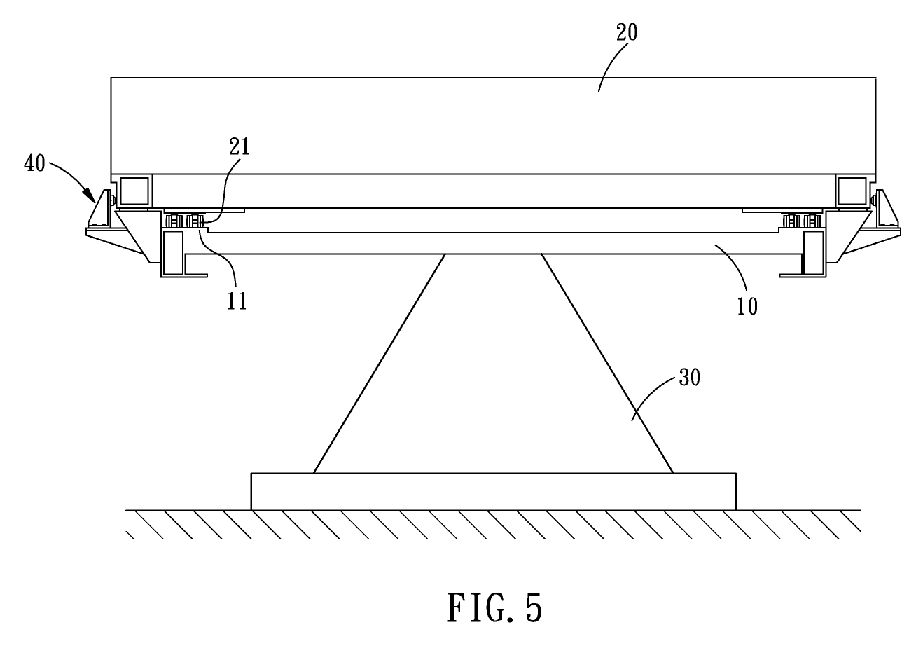

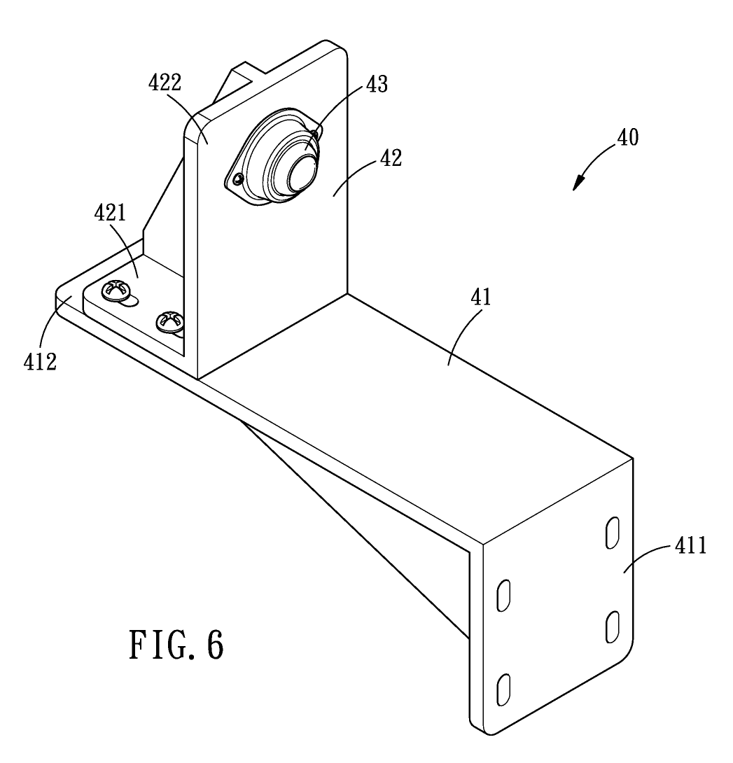

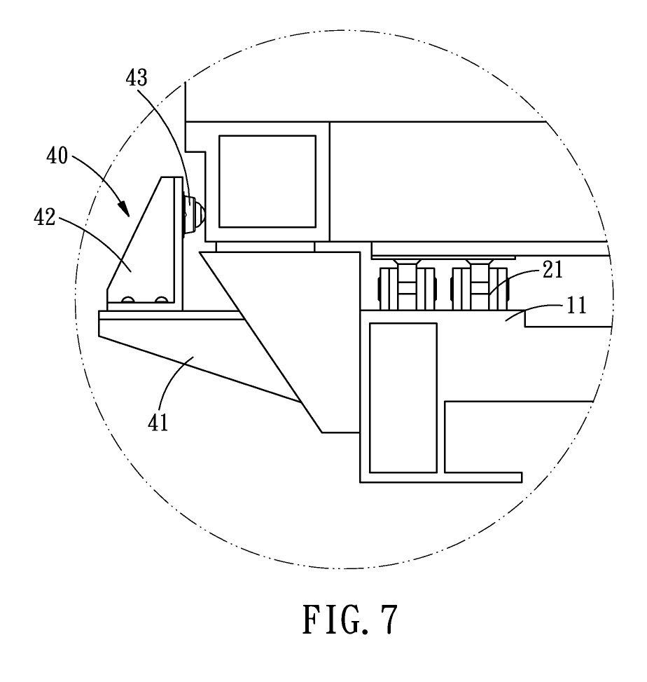

Referring to FIGS. 5-7, a universal wheel 43 is mounted on the stopping portion 422 of the restriction member 42 of each of the anti-deviation structures 40 by screws and in rolling contact with the positioning platform 20.

At both sides of the top surface of the carrying apparatus 10 are defined a sliding way 11, respectively. At both sides of the bottom surface of the positioning platform 20 are provided two wheels 21, respectively, in such a manner that the wheels 21 are in rolling contact with the sliding ways 11 of the carrying apparatus 10.

While we have shown and described various embodiments in accordance with the present invention, it should be clear to those skilled in the art that further embodiments may be made without departing from the scope of the present invention.

What is claimed is:

1. A carrying apparatus capable of preventing deviation of a positioning platform carried by it, comprising:
a positioning platform provided on a top of the carrying apparatus;
a support base provided at a bottom of the carrying apparatus; and
a plurality of anti-deviation structures provided at both lateral sides of the carrying apparatus, the respective anti-deviation structures being provided with a support member and a restriction member, the support member of the respective anti-deviation structures being provided with an assembly portion and a carrying portion, the restriction member of the respective anti-deviation structures being provided with an assembly portion and a stopping portion, the assembly portions of the support members being detachably assembled to the lateral sides of the carrying apparatus, the assembly portions of the restriction members being detachably assembled to the carrying portions of the support members, so as to restrict the positioning platform by the stopping portions of the restriction members.

2. The carrying apparatus capable of preventing deviation of a positioning platform carried by it as claimed in claim 1, wherein a universal wheel is mounted on the stopping portion of the restriction member of the respective anti-deviation structures and in rolling contact with the positioning platform.

3. The carrying apparatus capable of preventing deviation of a positioning platform carried by it as claimed in claim 2, wherein at least one sliding way is defined in a top surface of the carrying apparatus, and a plurality of wheels is provided on a bottom surface of the positioning platform and in rolling contact with the sliding way of the carrying apparatus.
